(19) United States
(12) Patent Application Publication
(10) Pub. No.: US 2017/0039523 A1
(43) Pub. Date: Feb. 9, 2017

(54) INTERVIEWING SYSTEM AND METHOD

(71) Applicant: Ocubicle Inc., Sugar Land, TX (US)

(72) Inventor: Olorunyomi Rotimi, Sugar Land, TX (US)

(73) Assignee: OCUBICLE INC., Sugar Land, TX (US)

(21) Appl. No.: 14/820,498

(22) Filed: Aug. 6, 2015

(51) Int. Cl. G06Q 10/10; G06F 19/00; G06F 17/30; H04L 29/06

(52) U.S. Cl. CPC G06Q 10/1053; H04L 65/1083; G06F 19/3406; G06F 17/30867; G06F 17/3053; H04L 63/083

(57) ABSTRACT

An interview system has a two-way communication device configured to enable an interview candidate and one or more interviewers to communicate in real time, an on-line repository for a database, wherein the interview candidate places a resume having one or more qualifications on the repository, and an interviewer has access to view resumes in the repository, one or more open positions having requirements provided by an interviewer, wherein an interview candidate in able to submit a resume where the requirements at least partially match the qualifications, and a score from the one or more interviewers for a candidate based on one or more of a candidate's qualifications, education, personality and communication. The interview system may have one or more biomonitoring devices configured to monitor the interviewee.

### BACKGROUND OF THE INVENTION

### 1. Field of Invention

This invention relates to systems that facilitate the interviewing of candidates for jobs.

### 2. Description of Related Art

In the past, job interviews have been arranged face-to-face with Human Resources departments or hiring managers. It is customary for recruiters to conduct phone interviews in order to reduce the number of prospective candidates, before deciding on a shorter list of candidates to be interviewed face-to-face. Some utilize video interviews during which prospective candidates are asked preset questions via computer software and their responses are recorded and evaluated. Before being considered for interview, prospective candidates are typically asked to complete extensive applications and/or personality assessments. All of the aforementioned interview modes are inefficient and redundant. Studies have repeatedly shown that they cannot be used to accurately predict whether or not a candidate will be a good employee.

Therefore, there is a need in the art for an interviewing medium that permits an online recording of a video interview “teaser”, hosted on a friendly URL that enables further information and easy search of the candidate's qualifications. Furthermore, it would be beneficial for a hiring team to be able to store assessment of the candidate's qualifications, and for an employer to advertise job postings and keep in touch with candidates through a social-network type of interface.

### SUMMARY OF THE INVENTION

An interview system has a two-way communication device configured to enable an interview candidate and one or more interviewers to communicate in real time, an on-line repository for a database, wherein the interview candidate places a resume having one or more qualifications on the repository, and an interviewer has access to view resumes in the repository, one or more open positions having requirements provided by an interviewer, wherein an interview candidate in able to submit a resume where the requirements at least partially match the qualifications, and a score from the one or more interviewers for a candidate based on one or more of a candidate's qualifications, education, personality and communication.

The interview system may have a resume search engine configured to search the resumes within the repository. An interview may be scheduled as a session and the session has a pass-code.

The interview system may have one or more biomonitoring devices configured to monitor the interviewee, and wherein the score is partially based on results of the biomonitoring devices, and the biomonitoring devices may be one or more of a web-cam and retinal tracker, a sphygmomanometer, and a pulse monitor.

The interview system may also have analysis of vocal parameters to determine a candidate's emotional state and attitude, wherein the emotional state and attitude is communicated to the interviewer.

The online repository may contain a user profile, editable by the user, and one or more privacy settings for the online repository as user-adjustable. The repository stores scores from previous interviews, which may be communicated to the interviewer, and the interviewer may hire the candidate immediately by pushing a hire now button.

A method of hiring a candidate has the steps of considering a first set of criteria, namely, age range, location, skills, experience and education, considering a second set of criteria, namely average ratings from previous applications, video resume appraisal, as well as relevance of keywords in resumes, considering a third set of criteria, namely interview performance scores and test scores, calculating a score by averaging the first, second and third set of criteria, the first and third set of criteria or the second and third set of criteria, and selecting a recommendation based on the outcome of the option chosen.

The foregoing, and other features and advantages of the invention, will be apparent from the following, more particular description of the preferred embodiments of the invention, the accompanying drawings, and the claims.

### BRIEF DESCRIPTION OF THE DRAWINGS

For a more complete understanding of the present invention, the objects and advantages thereof, reference is now made to the ensuing descriptions taken in connection with the accompanying drawings briefly described as follows.

FIG. 1 is a flowchart diagram of an algorithm, according to preferred embodiments of the invention.

### DETAILED DESCRIPTION OF PREFERRED EMBODIMENTS

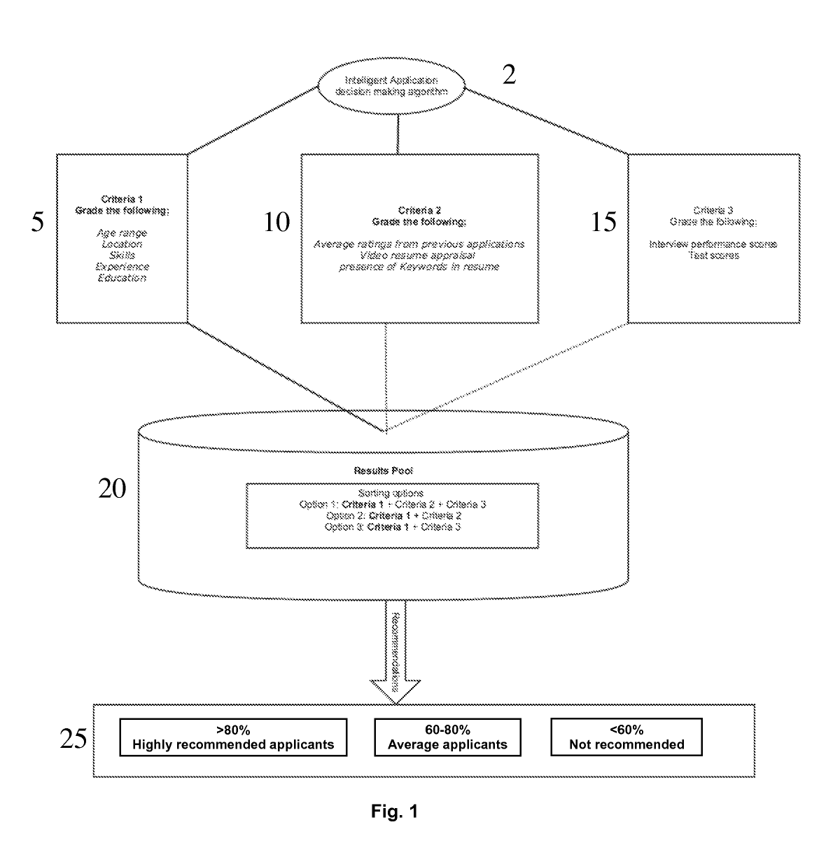

Preferred embodiments of the present invention and their advantages may be understood by referring to FIG. 1, wherein like reference numerals refer to like elements.

With the invention, users can create a resume profile that consists of a two-minute (maximum) video resume (customized code prevents resume video from exceeding two minutes). The video allows the user to show why he or she is the best candidate for a particular job. Things that cannot be easily integrated into written resumes (i.e. skills, experience and energy) could be verbalized in one's video resume, all while retaining the key aspects of traditional resumes on one's profile page.

Users have a unique and friendly resume web page URL e.g. www.resume.com/resumes/mary-cole-1 or www.resume.com/mary-cole-1. Users would not forward resumes as documents, but instead as personal web links to the web page. Users can also modify the appearance of their resume web page via text (containing detailed information about the candidate and their qualifications) and page formatting, and can share, forward or promote their resume profiles to their social and professional networks via a single click of a button. This will make user resume profiles go viral, thereby increasing one's target audience and outreach. Users that subscribe to the premium version of the application will be displayed first in search results above other non-premium users. They will also be identified with a unique “premium badge.”

Premium users can upload a maximum of five different video resumes to their profile, as opposed to regular users who can only upload a single video resume. When a user applies for a job vacancy, the employer can rate the user's application in relation to the job opening, and this rating will be saved to the user's resume profile. Other employers can use the aggregated user ratings as a filtering criterion when searching the resume database for potential hires. A higher score rating from previous employers can lead to higher possibility of getting invited for interview or getting hired. Users may be invited directly by employers to apply for private job openings (job vacancies not publicly listed). Users are notified when someone views their video resume; hence users will be aware if their resume profile is generating enough traction. Users can show work samples and demonstrations to the hiring manager during the pre-interview process via the secure direct mail system that connects users to companies that have invited them to chat. Users can control their privacy settings by making their profile visible via the resume search engine or by keeping it private and sending profile links to people of their choice.

For employers and hiring managers, the application allows employers to search for, find, and engage with candidates without posting job advertisements or engaging recruitment agencies. This application also serves as a public resume search engine. Anyone can look up qualified candidates based on location, skills, experience and other key words/phrases. The database is queried in milliseconds and a highly refined result-set containing the best fit is displayed based on the search criteria. Improved database structural design and the use of database table indexing significantly reduces the data retrieval time, a customized procedural code runs implicitly to automatically re-order and refine the result set before it is displayed.

By eliminating the need for advertising job vacancies and by reducing the number of poor candidates invited for interview, this application would save employers time and money. There is an internal score-sheet system that works similar to an Applicant Tracking System but in a more simplified and effective way. This helps manage the entire recruitment process from start to finish. It manages a list of all applications, shortlists applicants in stages, grades applicants' applications and overall performances and directly communicates with applicants before and during the recruitment exercise.

The function may be written in php, and the algorithm looks for trends, keywords, and other defined data in the applicant's profile/record to determine the most qualified applicant.

Applicants can be filtered out or sorted based on overall performance, ratings from previous hiring managers, test and interview scores, and so on. When a vacancy is created; the employer can determine application eligibility by defining application criteria; for example, applicant must be aged 19-30; educated at Stanford or Harvard, and having the following skills: database research, software development and integration, and mobile app development. Users that do not meet these criteria would not be allowed to apply. The hiring manager can decide to allow certain users that meet a particular percentage of his or her defined criteria. As a result, hiring managers can ensure that candidates will meet quality expectations and will save time and money in the process.

Job vacancies can be made private or public. If private, only invited users can apply, whereas anyone can apply for public vacancies. There is a feature that enables the hiring department/team of a company in different locations to collaborate in real-time and make hiring decisions. It enables delegation of duties based on rights assigned to each member of the team (each member may have multiple rights). Rights that may be assigned to members of the team include, but are not limited to, the following: the right to shortlist candidates from the pull of applicants, the right to invite shortlisted candidates, the right to grade applicants. Previously closed vacancies, whether filled or unfilled, can be re-opened for candidates to start applying. Employers can search the resume database and directly contact users of their choice for further discussion or to invite them to apply for a publicly or privately placed job vacancy.

Using the Cloud Interview feature, employers can schedule users for a cloud-based interview; this feature can invite users for an interview scheduled for a period in the future (e.g. within a 48-hour window). The interview can be held in the cloud for 5-60 minutes depending on the employer's preference.

Once invited, the user will receive the interview pass-code via email and/or text message. The interview pass-code automatically expires after the duration of the interview. The employer can decide to manually expire an interviewee's pass-code before the interview commences. Both parties require devices with separate audio microphones (such as those mounted within mouthpieces), speakers, a high-definition web-cam and broadband Internet connection. The audio can be in the form of an integrated headset with a mouthpiece (whether separate or integrated into the headset) or as a combination of microphone/speakers within a laptop, for example. The objective is clear communication. In addition, the web-cam provides an image of the interviewee and information about the interviewee's responses (i.e. body language). Further, one or more monitoring devices may be used to determine the physical disposition of the interviewee.

Further, one or more biomonitoring techniques may be used in accordance with the interview application. The web-cam may be equipped with a retinal scanner to verify the identity of the interviewee prior to interview. The web-cam may also track eye movement to analyze interviewee-computer interactions. Certain biometric techniques used in lie detection may be applied to determine the disposition of the interviewee. Polygraphs typically measure and record multiple physiological indices including blood pressure, pulse and skin conductivity. Electronic sphygmomanometers can be fastened to the interviewee's arm to track changes in blood pressure over the course of the interview. Pulse oximeters are small devices that can latch on to the interviewee's finger to track changes in heart rate. Alternatively, a wrist-bound device such as FitBit or a device of similar design can be used to track measure pulse. Tactile sensors are simple electrodes that can be attached to the interviewee's hand to measure changes in skin conductivity (perspiration). Certain of these techniques also reveal interviewees' tolerance for stress and physical reaction time, which may be important considerations in the hiring process. Biomonitoring measurements are recorded by the user's phone via Bluetooth, stored in the application, and made available for later viewing by the hiring manager.

Further a software application may be integrated that analyses and interprets human emotions, such as that offered by Nemesysco™. The software may use a set of vocal parameters that correlate with human emotions and to identify deceptive intentions in interview situations extrapolating to real-life situations. Layered voice analysis may be performed in real time or off-line on pre-recorded material. Vocal properties found to indicate embarrassment, excitement, concentration and anticipation are used, and these patterns are determined from a historical database based on the interviewee's culture and nationality, as well as universal vocal characteristics.

The hiring manager can decide to make the interview an oral interview, written aptitude test or a combination of both. The hiring manager has full access to set interview questions before the interview commences, and scores may be inputted internally as well. Hiring team members can be connected to the interview from various locations with the option of making themselves visible or not visible to the interviewee.

At the end of each interview session the employers receive the results of the behavioural analysis and is able to determine areas wherein the interviewee is less confident, has lied or is apprehensive. The employers may be given the option to reject a user application, shortlist the applicant or place the applicant on hold in a reserved list. The applicant signs off at the end of his session and awaits decision from the interviewer. Should the applicant decide to follow up on the interview, they may create a brief video using the device(s) at hand, which will be made available to the employer for review.

There is an additional individual rating feature that gives every member of the hiring team witnessing the interview session the option to grade the interviewee. The aggregate score is collated and displayed for all the team members to see. It is also stored in the central project file against the interviewee's record pending when final decision is taken. At each point in time, there is an inbuilt algorithm that runs through all applications and recommends the applicant to be hired. This checks all applicants' inputted scores, ratings by previous employers, ratings based on applicant's skills, grades and experience. Based on these algorithms, recommendations are offered with or without further discussion. It is the hiring manager's prerogative.

With reference to FIG. 1, in an exemplary embodiment, in step 2 the interview system is initiated. In step 5 the first set of criteria, namely, age range, location, skills, experience and education are considered. In step 10 the second set of criteria, namely average ratings from previous applications, video resume appraisal, as well as relevance of keywords in resumes, are considered. In step 15, the third set of criteria, namely interview performance scores and test scores are considered. In step 20, in the results pool, an option of score calculation is considered. In Option 1, the values for the first, second and third set of criteria are added, and in an embodiment, averaged. In Option 2, the values for the first and second criteria are added and averaged. In Option 3, the values for the first and third criteria are added and averaged. In step 25 a recommendation is made based on the outcome of the Option chosen, and the candidate may be above average (recommended), average or below average (not recommended).

There is also the option of saving the session. The session will saved on the central server for 48 hours and a link to download each session will be made available to the employer. Additionally, there is “HIRE NOW” button that selects the final candidate once it is clicked against the candidates record. Multiple candidates may be hired.

The essence of the cloud interview application is to ensure the entire hiring can take place remotely without a face-to-face interview. All negotiations may be performed remotely through the application, and documents may be submitted through its messaging feature. Nevertheless, it is the interviewer's prerogative to determine if the interviewee should come in for negotiations, which would be under-utilizing the application.

Only a single administrator on the hiring team can select the final candidate(s). The interview feature is more than just video conferencing; it also involves user behavior analytics. Biomonitoring devices designed to monitor autonomic nervous system responses including spikes in heart rate, blood pressure, increased perspiration, pupil dilation and intense breathing are used to provide a physiological stress-response user profile. Optimized algorithms applied in real time and statistical analysis are used to extract meaningful information from said profile. Fear, anxiety, depression, excitement and anger can all be detected and quantified in reductive fashion. This overall report is then made available to the interviewers for decision-making.

A prospective employer may “poke” a user, indicating that the user has been noticed by the prospective employer/company or hiring manager and may be interested in discussing options now or in the future. The employer and user will receive each other's status updates in order to monitor hiring progress.

A user's status update is like the state of mind of an employee or potential employee. The updates may include current availability, “just settling in”, “settled”, “unsettled”, and whether the employee is open to new options. The user may screen their present employer from viewing the status. Users also may follow companies to be notified of job vacancies posted by anyone they follow.

As an example of an implementation, a server infrastructure may comprise:
a. Processor: Dual Processor Intel Xeon E5 2630 V3
b. Threads: 32 Threads
c. Clock speed: 2.4 Ghz X 32
d. Turbo speed: 3.2 Ghz X 32
e. CPU BENCHMARK: 19282
f. Memory: 64 GB
g. Hard Drive & Solid State Disk: 4 TB
h. Network port speed: Dedicated 1 Gbps Port
i. Operating System: CentOS

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

I claim:

1. An interview system comprising:
a. a two-way communication device configured to enable an interview candidate and one or more interviewers to communicate in real time;
b. an on-line repository for a database, wherein the interview candidate places a resume having one or more qualifications on the repository, and an interviewer has access to view resumes in the repository;
c. one or more open positions having requirements provided by an interviewer, wherein an interview candidate in able to submit a resume where the requirements at least partially match the qualifications; and
d. a score from the one or more interviewers for a candidate based on one or more of a candidate's qualifications, education, personality and communication.

2. The interview system of claim 1 further comprising a resume search engine configured to search the resumes within the repository.

3. The interview system of claim 1 wherein the interview is scheduled as a session and the session has a pass-code.

4. The interview system of claim 1 further comprising one or more biomonitoring devices configured to monitor the interviewee, and wherein the score is partially based on results of the biomonitoring devices.

5. The interview system of claim 4 wherein the biomonitoring devices comprise one or more of a web-cam and retinal tracker, a sphygmomanometer, and a pulse monitor.

6. The interview system of claim 1 further comprising analysis of vocal parameters to determine a candidate's emotional state and attitude, wherein the emotional state and attitude is communicated to the interviewer.

7. The interview system of claim 1 wherein the online repository contains a user profile, editable by the user.

8. The interview system of claim 1 wherein one or more privacy settings for the online repository as user-adjustable.

9. The interview system of claim 1 wherein the repository stores scores from previous interviews and communicates the scores to the interviewer.

10. The interview system of claim 1 wherein the interviewer may hire the candidate immediately by pushing a hire now button.

11. A method of hiring a candidate, comprising the steps of:
a. considering a first set of criteria, namely, age range, location, skills, experience and education;
b. considering a second set of criteria, namely average ratings from previous applications, video resume appraisal, as well as relevance of keywords in resumes;
c. considering a third set of criteria, namely interview performance scores and test scores;
d. calculating a score by averaging the first, second and third set of criteria, the first and third set of criteria or the second and third set of criteria; and
e. selecting a recommendation based on the outcome of the option chosen.
